(19) United States
(12) Patent Application Publication
(10) Pub. No.: US 2009/0310434 A1
(43) Pub. Date: Dec. 17, 2009

(54) Method, Apparatus and System For High-Precision Metering and/or Mixing of Liquids

(76) Inventors: Uwe Kampmeyer, Dortmund (DE); Ron Meyknecht, Munster (DE); Ulrike Michelsen, Hattingen (DE); Markus Rawert, Coesfeld (DE)

Correspondence Address: Kubotera & Associates, LLC, 200 Daingerfield Rd, Suite 202, Alexandria, VA, 22314, US

(21) Appl. No.: 11/578,588

(22) PCT Filed: Apr. 12, 2005
(86) PCT No.: PCT/EP2005/003839

§ 371 Date: Oct. 16, 2006

(30) Foreign Application Priority Data
Apr. 14, 2004 (DE) 102004018006.7

(51) Int. Cl. B01F 15/02

(52) U.S. Cl. 366/132

(57) ABSTRACT

Method for high-precision metering and/or mixing of liquids, having electrical means for production of an electrostatic field using the electrospray effect, with a liquid being metered, and means for weight determination, in which the means for weight determination are used in order to meter the amount of liquid. The method for high-precision metering and/or mixing of liquids also has a combination of first and second metering means. The first metering means comprises mechanical means for reducing the volume of a liquid reservoir, and the second metering means comprises the electrical means for production of an electrical field using the electrospray effect, and a combination of first and second control means for controlling the magnitude of the metered liquid. The first control means comprises means for determining the volume of the reservoir and the second control means comprises the means for determining the weight of the metered liquid. An apparatus for carrying out the method comprises a control unit for controlling the first and second metering means, using signals from the first and second control means. A system comprises a large number of reservoirs, which are arranged in an XY matrix tray.

The present invention relates to a method, an apparatus and a system for high-precision liquid metering and/or mixing using the electrospray effect, in particular for liquids, which comprise a flavour substance and/or scent substance and/or active substance and/or pharmaceutical means and/or biological means.

Methods for metering of liquids using the electrospray effect are known, for example, from DE 19847421 A1, US 20020003177 A1, UK 14337686 A and JP 03-329935. The methods and apparatuses known from these documents make use of the electrospray effect in order to meter a liquid in the form of droplets, with the amount metered in each case being determined by special electrode arrangements and/or variation of the voltage of the electrostatic field, so that a predetermined number of predetermined droplets are metered from a reservoir into a vessel.

For many applications, it is desirable to provide high-precision metering of liquids which is greater than the precision of the emission of droplets in known methods and apparatuses.

The large EP 1209602 A2 discloses a computer-controlled production method which utilizes a communicative link between at least two computers, with the first computer transmitting to the second computer instructions relating to the production of a predetermined substance, and in which the instructions may comprise a commercial secret. The second computer makes use of the instructions from the first computer to control an apparatus for production of the predetermined substance.

For this known production method, which may comprise a commercial secret, and in particular for metering and/or mixing of at least one liquid which may comprise an active substance and/or flavour substance and/or scent substance and/or pharmaceutical means and/or biological means, in which the mixing may comprise a commercial secret, it is desirable to specify a method and apparatus for high-precision metering and/or mixing of a liquid.

The object of the present invention is thus to specify a method, an apparatus and a system for high-precision liquid metering and/or mixing using the electrospray effect, whose accuracy is better than that of the known methods and apparatuses and which is suitable for a production method for mixing and/or metering of at least one liquid, in which the metering and/or mixing may comprise a commercial secret.

The objects are achieved by the features of the two independent claims 1 and 5. Advantageous embodiments of the present invention are mentioned in the dependent claims and/or in the following description, which is accompanied by schematic drawings, in which:

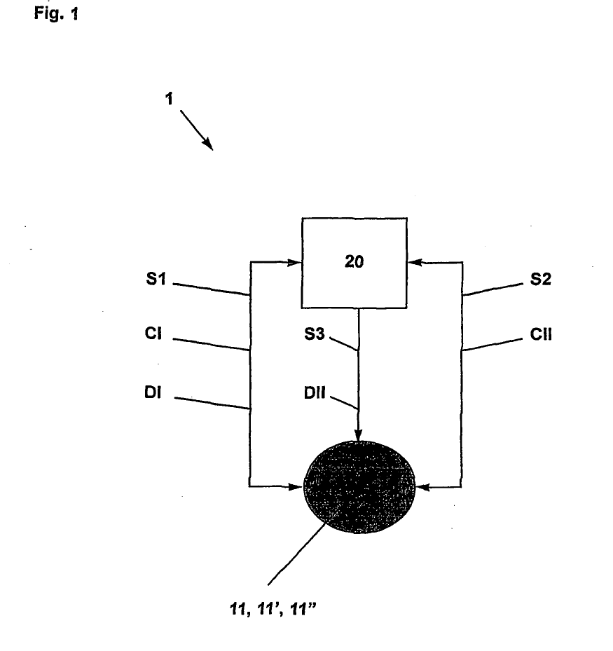

FIG. 1 shows a schematic illustration of the steps in the method according to the invention;

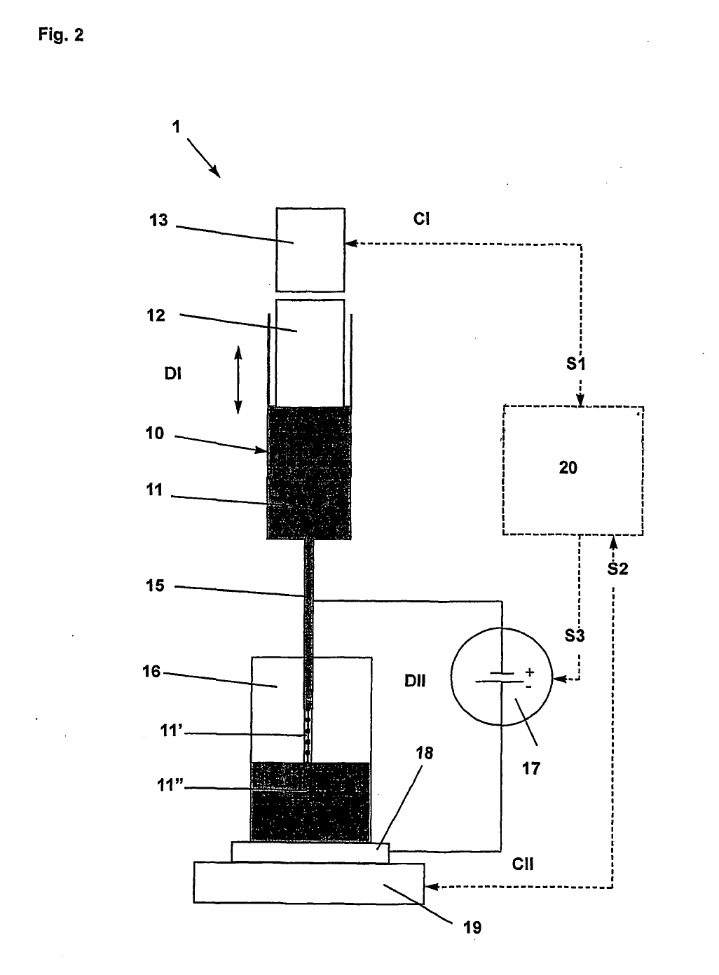

FIG. 2 shows a schematic illustration of the apparatus according to the invention; and

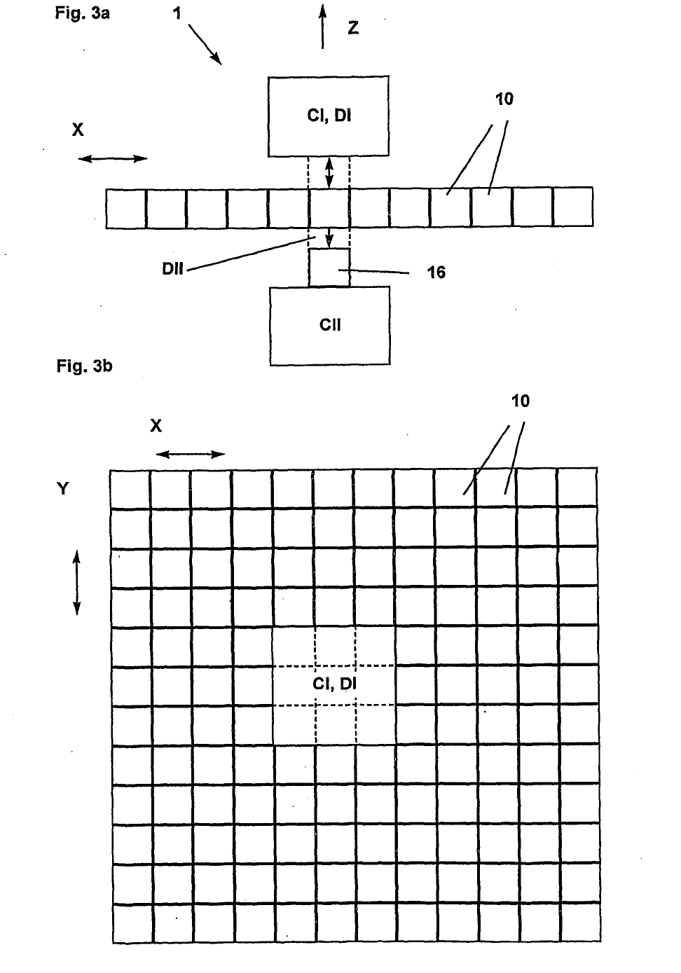

FIGS. 3a and b show a schematic illustration of the system according to the invention.

The fundamental concepts of the present invention are to specify a method and/or an apparatus for high-precision liquid metering and/or mixing, which each comprise electrical means for production of an electrostatic field using the electrospray effect, such that a liquid is metered, and which furthermore comprise means for weight determination, in which the means for weight determination are used in order to control the magnitude of the metered liquid with high precision. The apparatus according to the invention for this purpose comprises a control unit using a signal from the weight-determination means.

The method according to the invention and the apparatus according to the invention in this case advantageously comprise a combination of first and second metering means, in which the first metering means comprises mechanical means for reducing the volume of a liquid reservoir, and the second metering means comprises electrical means for production of an electrostatic field using the electrospray effect, and, furthermore, a combination of first and second control means for controlling the magnitude of the metered liquid, in which the first control means comprises determination of the volume of the reservoir, and the second control means comprises determination of the weight of the metered liquid. For this purpose, the apparatus according to the invention comprises a control unit for controlling the first and second metering means using signals from the first and second control means.

The first and second control means and/or the first and second metering means can be used or connected in a suitable manner at the same time and/or alternately.

The method according to the invention and the apparatus according to the invention are particularly suitable for a system according to the invention for high-precision liquid metering and/or mixing, which comprises a large number of liquid reservoirs which are arranged in an XY matrix tray, in which the XY matrix tray is arranged between the first and second control means, and which also comprises an XY position control system, which is designed in such a manner that a predetermined reservoir (10) is arranged between the first and the second control means.

The method according to the invention, the apparatus according to the invention and the system according to the invention are particularly suitable for metering and/or mixing at least one liquid, which comprises an active substance and/or flavour substance and/or scent substance and/or pharmaceutical means and/or biological means, in which the mixing process may comprise a commercial secret, and in which the method and/or the apparatus and/or the system are/is controlled in a suitable manner by an electronic computer, which may be linked to a local and/or a global computer network and communicates with at least one computer in the computer network, and/or is at least partially controlled by it, and in which a predetermined mixture ratio and/or commercial secret is specified via the communication and/or control of the computer.

The present invention will be described in detail in the following text with reference to the schematic drawings.

FIG. 1 shows a schematic illustration of the fundamental steps in the method according to the invention and of the basic configuration of the apparatus 1 according to the invention for metering of a liquid 11, 11′, 11″. A control unit 20 controls a first control means CI for controlling the magnitude of the metered liquid 11, 11′, 11″ and a second control means CII, likewise for controlling the magnitude of the metered liquid 11, 11′, 11 ″. The control unit 20 also controls a first DI and second DII metering means for metering of the liquid 11, 11′, 11″, in which the control unit 20 according to the invention uses a first signal S1 from the first control means CI, and a second signal S2 from the second control means CII.

According to the invention, the second metering means DII comprises electrical means for production of an electrostatic field using the electrospray effect, and the second control means CII comprises means for determining the weight of the metered liquid 11, 11′, 11″, which are produced in a suitable manner by a high-precision balance. The first means CI for controlling the magnitude of the metered liquid 11, 11′, 11″ is produced in a suitable manner by means for determining the volume of a liquid reservoir, and the first metering means DI is produced in a suitable manner by mechanical means for reducing the volume of the liquid reservoir.

According to the invention, the control unit 20 can also be designed in such a manner that the first DI and second DII metering means and/or the first CI and second CII control means are used at the same time or alternately, in which the magnitude of the metered liquid 11, 11′, 11″ can be adjusted with high precision and resolution by the weight determination and/or volume determination and/or reduction in volume of the reservoir and/or voltage of the electrostatic field, and at the same time very small amounts of liquid can be metered, or else a multiple of the very small amounts of liquid can be metered.

FIG. 2 shows a schematic illustration of the apparatus 1 according to the invention with a liquid 11 which is provided in a suitable reservoir 10, and a means for volume reduction DI, which is provided in a suitable manner by a piston 12 which is arranged in the liquid reservoir 10, and advantageously interacts with a closed-loop motor 13, which advantageously provides the first control means CI and is controlled by the control unit 20, and at the same time sends first signals S1 to the control unit 20, by which means the volume of the liquid reservoir 10 is measured. The liquid reservoir 10 comprises a suitably designed metering head 15, in a suitable manner, and is arranged above a vessel 16 for holding the metered liquid 11′, 11″, with the vessel 16 arranged on the means for weight determination CII, which comprises a high-precision balance 10 in a suitable manner, and produces appropriate weight measurement signals S2 for the control unit 20.

The means according to the invention for production of an electrostatic field using the electrospray effect DII comprise, in a suitable manner, a voltage generator 17 which interacts with suitable electrodes 18 and 18′ in such a manner that a suitable electrostatic field is produced, and a predetermined amount of liquid 11 is emitted via the metering head 15 into the vessel 16. The magnitude of the voltage that is produced by the voltage generator 17 and the magnitude of the electrostatic field associated with this, and the magnitude of the metered liquid 11′, 11″ associated with this are in this case determined according to the invention by the control unit 20 using the signals S1 and S2 from the first CI and second CII control means, in which case the liquid 11′, 11″ can be produced from the metering head 15 in the form of a jet, and/or small droplets and/or a mist. Suitable arrangements of the electrodes 18, 18′ are known from the initially cited prior art, and may vary in many ways. By way of example and advantageously, a negative electrode 18 can be arranged underneath the vessel 16, and a positive electrode 18′ can be connected to a conductive metering head 15.

It is obvious that, in the drawings, means which are not illustrated for screening the electrode 18 and the electrostatic field from the high-precision balance 19 can increase the accuracy of the balance 19. As stated initially, the closed-loop motor 13 and/or the voltage generator 17 and/or the precision balance 19 may, according to the invention, be used or switched at the same time or alternately, thus, according to the invention, allowing the liquid 11′, 11″ to be metered in very accurate and small amounts, or else allowing the metering of a large number of very small amounts.

FIG. 3a shows a side view of a system according to the invention for high-precision metering and/or mixing of liquids, and FIG. 3b shows a schematic plan view of the system according to the invention. The system according to the invention comprises, in a suitable manner, a large number of reservoirs 10 which are arranged in a suitable manner in an XY matrix tray 101, in such a manner that a selected predetermined reservoir 10 is arranged between the first and second CI and CII control means according to the invention and, in addition, between the first DI and second DII metering means. The system according to the invention also comprises an XY position control system, in which the tray 101 is manipulated in such a manner that a selected reservoir 10 is arranged between the first CI and second CII control means, and also between the first DI and second DII metering means.

It is obvious that the XY positioning system can carry out linear and/or rotary movements for selection of a predetermined reservoir.

In this way, the method according to the invention as described above and/or the apparatus 1 according to the invention can be used to provide a predetermined mixture of a liquid 11 in the vessel 16 from at least one liquid from at least one reservoir 10 from the large number of reservoirs 10 in the tray 101.

The apparatus 1 according to the invention, the method according to the invention and the system according to the invention are linked in a suitable manner to an electronic computer and are controlled by it, in which case the electronic computer may, in a suitable manner, comprise the control unit 20. The electronic computer may be linked in a suitable manner to a local and/or global computer network, in which the electronic computer advantageously communicates with at least one computer in the computer network, or is at least partly controlled by it.

The method according to the invention, the apparatus 1 according to the invention and the system according to the invention can be used in a suitable manner for metering and/or mixing of at least one liquid, in which the liquid may comprise, in a suitable manner, an active substance and/or flavour substance and/or scent substance and/or pharmaceutical means and/or biological means, and in which the mixture may comprise a commercial secret, which is transmitted to the electronic computer which controls the method, the apparatus 1 and the system, via the computer network in an encrypted form from another computer.

1. Method for high-precision metering and/or mixing of liquids, having:
electrical means for production of an electrostatic field using the electrospray effect, with a liquid (11, 11′, 11″) being metered, and
means for weight determination, in which the means for weight determination are used in order to meter the amount of liquid (11, 11′, 11″).

2. Method according to claim 1, also having:
a combination of first (DI) and second (DII) metering means; the first metering means (DI) comprises mechanical means for volume reduction of a liquid reservoir (10); and
the second metering means (DII) comprises the electrical means for production of an electrical field using the electrospray effect; and
a combination of first (CI) and second (CII) control means for controlling the magnitude of the metered liquid (11, 11′, 11″);
the first (CI) control means comprises means for determining the volume of the reservoir (10); and
the second (CII) control means comprises means for determining the weight of the metered liquid (11, 11′, 11″); and
a control unit (20) for controlling the first (DI) and second (DII) metering means using signals (S1, S2) from the first (CI) and second (CII) control means.

3. Method according to claim 2, in which:
the first (DI) and second (DII) metering means and/or the first (CI) and second (CII) control means are used at the same time.

4. Method according to claim 2, in which:
the first (DI) and second (DII) metering means and/or the first (CI) and second (CII) control means are used alternately.

5. Apparatus for high-precision metering and/or mixing of a liquid, having:
electrical means for production of an electrostatic field using the electrospray effect, with a liquid (11, 11′, 11″) being metered, and
means for weight determination, and
a control unit (20) for controlling the magnitude of the metered liquid (11, 11′, 11″) using a signal (S2) from the weight determination means.

6. Apparatus (1) according to claim 5, also having:
a combination of first (DI) and second (DII) metering means; the first metering means (DI) comprises mechanical means for volume reduction of a liquid reservoir (10); and
the second metering means (DII) comprises the electrical means for production of an electrical field using the electrospray effect; and
a combination of first (CI) and second (CII) control means for controlling the magnitude of the metered liquid (11, 11′, 11″);
the first (CI) control means comprises means for determining the volume of the reservoir (10); and the second (CII) control means comprises means for determining the weight of the metered liquid (11, 11′, 11″); and
the control unit (20) controls the first (DI) and second (DII) metering means using signals (S1, S2) from the first (CI) and second (CII) control means.

7. Apparatus according to claim 6, in which:
the control unit (20) is designed in such a manner that the first (DI) and second (DII) metering means and/or the first (CI) and second (CII) control means are controlled at the same time.

8. Apparatus (1) according to claim 6, in which:
the control unit (20) is designed in such a manner that the first (DI) and second (DII) metering means and/or the first (CI) and second (CII) control means are controlled alternately.

9. Apparatus (1) according to claim 6, in which:
the first (DI) metering means comprises a closed-loop motor (13), which interacts with a piston (12) which is arranged in the liquid reservoir (10);
the second (DII) metering means comprises a voltage generator (17), which produces a predetermined metering voltage for an electrostatic field between a first (18) and second (18′) electrode and is arranged in such a manner that the electrospray effect is produced, in which a liquid (11) is emitted from the reservoir (10) via a metering head (15) into a vessel (16);
the closed-loop motor (13) is used as the first (CI) control means;
the second (CII) control means comprises a high-precision balance (19);
the control means (20) comprises an electrical and/or electronic circuit (20).

10. Apparatus (1) according to claim 6, also having:
a large number of reservoirs (10) which are arranged in an XY matrix tray (101) between the first (CI) and the second (CII) control means, and
an XY position control system for controlling the tray (101);
which is designed and interacts with the tray (101) in such a manner that a selected reservoir (10) is arranged between the first (CI) and second (CII) control means.

11. Apparatus (1) according to claim 10, in which the control unit (20) and/or the XY position control system comprise/comprises an electronic computer and/or are/is connected to an electronic computer.

12. Apparatus (1) according to claim 11, in which the electronic computer is connected to a local and/or global computer network, and in which the electronic computer communicates with at least one computer in the computer network, and/or is at least partially controlled by it.

13. Use of the method according to claim 1 for metering and/or mixing of at least one liquid, which comprises a flavour substance and/or scent substance and/or active substance and/or pharmaceutical means and/or biological means.

14. Use according to claim 13 for production of a predetermined mixture of at least two liquids.

15. Use according to claim 14, in which the mixture comprises a commercial secret.

16. Use of the apparatus according to claim 5 for metering and/or mixing of at least one liquid, which comprises a flavour substance and/or scent substance and/or active substance and/or pharmaceutical means and/or biological means.

17. Use according to claim 16 for production of a predetermined mixture of at least two liquids.

18. Use according to claim 17, in which the mixture comprises a commercial secret.
